(19) United States
(12) Patent Application Publication
(10) Pub. No.: US 2019/0052819 A1
(43) Pub. Date: Feb. 14, 2019

(54) METHODS, APPARATUS AND ARTICLES OF MANUFACTURE TO PROTECT SENSITIVE INFORMATION IN VIDEO COLLABORATION SYSTEMS

(71) Applicant: Intel Corporation, Santa Clara, CA (US)

(72) Inventors: Oleg Pogorelik, Lapid (IL); Alex Nayshtut, Gan Yavne (IL); Omer Ben-Shalom, Rishon Le-Tzion (IL); Shay Pluderman, Jerusalem (IL); Roy Gavrielov, Rehovot (IL)

(21) Appl. No.: 15/825,876

(22) Filed: Nov. 29, 2017

(51) Int. Cl. H04N 5/272; G06K 9/46; G06F 17/30

(52) U.S. Cl. CPC H04N 5/272; H04L 65/403; G06F 17/30817; G06K 9/4604

(57) ABSTRACT

Methods, apparatus, systems and articles of manufacture to protect sensitive information in video collaboration systems are disclosed. A disclosed example method includes an analytics engine to recognize a feature in a first frame of a first video stream, a policy enforcer to apply an obscuration policy to the recognized feature to identify whether to mask the recognized feature, and a masker to obscure the recognized feature in the first frame to form a second frame in a second video stream.

### FIELD OF THE DISCLOSURE

This disclosure relates generally to video collaboration systems, and, more particularly, to methods, apparatus and articles of manufacture to protect sensitive information in video collaboration systems.

### BACKGROUND

Many modern conference and collaboration rooms are equipped with video collaboration equipment. Video collaboration systems enable people to see each other at a distance, and have more lively, emotional and/or productive interactions.

### BRIEF DESCRIPTION OF THE DRAWINGS

FIG. 1 illustrates an example video collaboration system in which an example masking streamer, in accordance with the disclosure, protects sensitive information.

FIG. 2 is a block diagram illustrating an example implementation of the example masking streamer of FIG. 1.

FIG. 3 is an example table that may be used to implement the example feature list data structure of FIG. 2.

FIG. 4 is an example table that may be used to implement the example policies data structure of FIG. 2.

FIG. 5 is a flowchart representing example processes that may be implemented as machine-readable instructions that may be executed to implement the example masking streamer of FIGS. 1 and 2 to protect sensitive information in video collaboration systems.

FIG. 6 illustrates an example processor platform structured to execute the example machine-readable instructions of FIG. 5 to implement the example masking streamer of FIGS. 1 and/or 2.

Wherever possible, the same reference numbers will be used throughout the drawing(s) and accompanying written description to refer to the same or like parts. Connecting lines or connectors shown in the various figures presented are intended to represent example functional relationships and/or physical or logical couplings between the various elements

### DETAILED DESCRIPTION

During video collaborations, people may want and/or need to exclude sensitive information from being exposed to another person. For example, a person may want and/or need to avoid sensitive documents, exposed computer screens, exposed mobile device screens, whiteboards, sketches on whiteboards, etc. from being exposed to another person. In current solutions, users are required to start and stop video transmission. Such current solutions are often associated with a poor user experience, some video equipment doesn't make starting and stopping video user friendly, users may forget to manually stop video transmission leading to inadvertent information leakage, meeting productivity may be reduced when video is disabled, etc. Some current solutions are performed off-line after a person sees the stream. Thus, in some current solutions, a person can maliciously edit a video stream by, for example, copying content before sensitive information is obscured.

Disclosed example masking streamers overcome these and other deficiencies of existing solutions. Disclosed example masking streamers protect sensitive information in video collaboration systems by recognizing (e.g., detecting, identifying, etc.) features (e.g., objects, persons, content, etc.) in a video that are associated with sensitive information, and obscuring (e.g., masking, covering, blurring, etc.) those features in the video stream. In some examples, the features are automatically recognized in real-time (e.g., as each frame is captured), and sensitive information automatically obscured in the video stream in accordance with policies before each frame is streamed, stored, etc., that is, before a frame can be seen by a person. Accordingly, sensitive information in frames can be obscured before the frames are seen by anyone, further reducing the chances for inadvertent exposure of sensitive information. Moreover, because obscuration is performed before the video is seen, the video stream can be protected against malicious editing, e.g., copying non-obscured video stream. In some examples, the masking streamer is implemented in hardware, in a trusted execution environment, etc. to prevent tampering with frames, object recognition and/or masking.

Reference will now be made in detail to non-limiting examples of this disclosure, examples of which are illustrated in the accompanying drawings. The examples are described below by referring to the drawings.

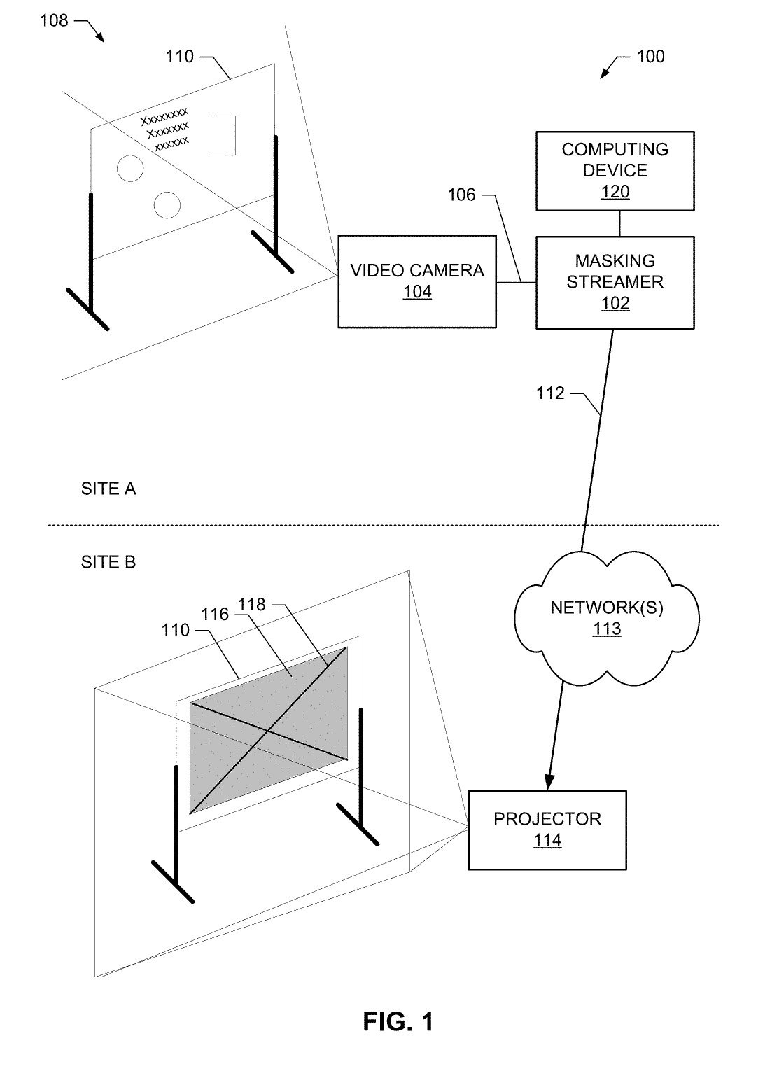

FIG. 1 illustrates an example video collaboration system 100 in which an example masking streamer 102, in accordance with the disclosure, protects sensitive information. To capture video streams, the example video collaboration system 100 includes an example video camera 104. In the illustrated example, the video camera 104 is providing a video stream 106 of an example scene 108. The example scene 108 of FIG. 1 includes an example whiteboard 110.

The example masking streamer 102 of FIG. 1 processes the video stream 106 to automatically recognize features (e.g., the example whiteboard 110) in each frame. The example masking streamer 102 applies one or more policies to the recognized features to determine which feature(s) in each frame to obscure. For features that are to be obscured in a frame, the example masking streamer 102 obscures (e.g., masks, covers, blurs, etc.) those features in the frame before the frame is, for example, stored, transmitted, seen, etc. In the illustrated example, a modified video stream 112 with the obscured features is transmitted to an example projector 114. The example projector 114 projects (e.g., presents, displays, etc.) the modified video stream 112. In the example of FIG. 1, the masking streamer 102 obscured the whiteboard 110 with a box and X. Accordingly, when the projector 114 projects the modified video stream 112, the whiteboard 110 is obscured with a box 116 and X 118. Thus, any sensitive information that may have been present on the whiteboard 110 is protected (e.g., blocked from being seen by others). In some examples, the masking streamer 102 is integrated, e.g., in a same housing, with the video camera 104 to further prevent access to non-obscured video streams. In some examples, the video camera 104 implements INTEL® REALSENSE™ technologies.

In the illustrated example, the masking streamer 102 and the video camera 104 are located at a SITE A, and the projector 114 is located at a SITE B. SITE A and SITE B may be any type(s) of sites (e.g., rooms, auditoriums, personal computers, mobile devices, etc.) separated by any geographic distance (e.g., locations in a building, different buildings, different cities, etc.). Data representing the modified video stream 112 may be conveyed using any number and/or type(s) of private and/or public networks 113, computer-readable storage medium or, more generally, any number and/or type(s) of communicative couplings. The data may be conveyed in real-time (e.g., as the video stream 106 is captured) or delayed (e.g., storage on a computer-readable storage medium).

The example media source 106 provides the media 104 and the audio 110 to the example media presentation device 114 using any number and/or type(s) of example public, and/or public network(s) 116 or, more generally, any number and/or type(s) of communicative couplings.

In some examples, a computing device 120 (e.g., a personal computer, a mobile device, a tablet, a gaming console, etc.) is communicatively coupled to the masking streamer 102 to provide (e.g., define, etc.) information on what features to identify, and/or what masking policy(-ies) (e.g., mask vs. not mask, blur vs. completely mask, etc.) to apply to the features. In some examples, the masking streamer 102 is integrated with the computing device 120, e.g., in a same housing.

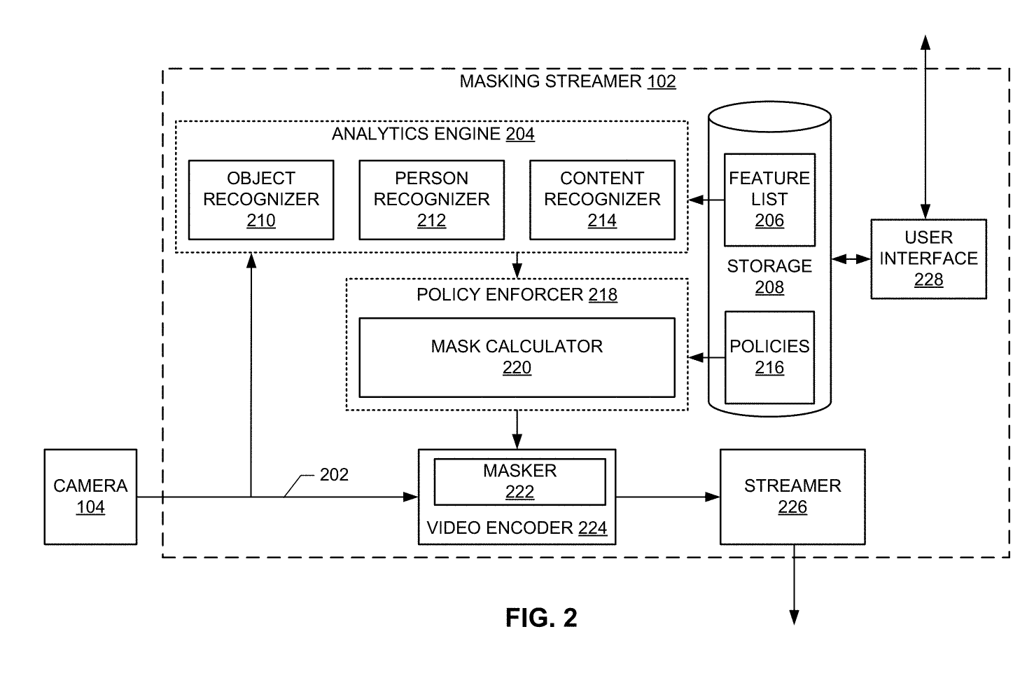

FIG. 2 is a block diagram of an example implementation of the example masking streamer 102 of FIG. 1. To recognize features in video frames 202, the example masking streamer 102 of FIG. 2 includes an example analytics engine 204. The example analytics engine 204 performs object recognition on the video frames 202 based on a set of features specified in an example feature list 206. The example feature list 206 may be implemented using any number and/or type(s) of data structures, and stored on any number and/or type(s) of computer-readable storage medium 208.

In the illustrated example of FIG. 2, the example analytics engine 204 includes an example object recognizer 210 to identify objects (e.g., a whiteboard, a flip chart, a computer screen, etc.), an example person recognizer 212 to identify persons in general and/or particular persons, and an example content recognizer 214 (e.g., a red box on a whiteboard, text, schematics, symbols, etc.). In some examples, the example recognizers 210, 212 and 214 recognize pre-defined generic objects, generic types of objects, etc. (e.g., a face, a screen, writing, etc.) that can recognize faces without having to be configured with everyone's faces, etc. While three example recognizers 210, 212 and 214 are shown in FIG. 2, any number and/or type(s) of recognizers may be implemented. In some examples, the object recognizer 210, the person recognizer 212, the content recognizer 214 and/or, more generally, the analytics engine 204 perform object recognition to identify features in the video frames 202. For instance, the object recognizer 210, the person recognizer 212, the content recognizer 214 and/or, more generally, the analytics engine 204 implement object recognition algorithms that perform matching, learning, and/or pattern recognition using appearance-based and/or feature-based techniques. In some examples, the object recognizer 210, the person recognizer 212, the content recognizer 214 and/or, more generally, the analytics engine 204 are implemented using a machine learning engine, a neural network, etc. In some such examples, the machine learning engine and/or the neural network are trained to recognize particular features and/or particular types of features using supervised and/or unsupervised learning. The example feature list 206 corresponds to the features that the analytics engine 204 has been trained to detect. In some examples, a machine learning engine and/or neural network is trained to simultaneously recognize a plurality of features.

To enforce sensitive information protection policies 216, the example masking streamer 102 includes an example policy enforcer 218. The example policies 216 of FIG. 2 may be implemented using any number and/or type(s) of data structures, and stored on any number and/or type(s) of computer-readable storage medium 208.

For each feature identified by the example analytics engine 204, the example policy enforcer 218 of FIG. 2 queries the example policies 216 to determine whether the feature is to be obscured. If a feature is to be obscured, an example mask calculator 220 obtains from the policies 216 the type of obscuration to be applied, and obtains from the analytics engine 204 the location, size, shape, dimension(s), etc. of the feature. The example mask calculator 220 determines the coordinates in the video frame that define the boundary of the feature to be obscured.

To apply the obscuration, the example masking streamer 102 includes an example masker 222. The example masker 222 of FIG. 2 computes obscuration data based on the location, size, shape, dimension(s), etc. of the feature computed by the mask calculator 220 that can be combined with or applied to the video frame 202 to obscure the feature in the image frame. For example, the obscuration data may be an image with NULL or missing pixels surrounding a rectangular area of black pixels. Combining such an obscuration image with the video frame 202 will overwrite the feature with a block box that obscures the feature. In some examples, the obscuring data and the video frame 202 need not be the same size. In some examples, such as a blurring obscuration, the masker 222 computes the obscuring data by applying a blurring function to the portion of the video frame 202 containing the image.

To encode video, the example masking streamer 102 includes an example video encoder 224. In the example of FIG. 2, the masker 222 is implemented together with the example video encoder 224 to leverage the video stream processing capabilities of the video encoder 224. However, the masker 222 and the video encoder 224 can be implemented separately. The video encoder 224 encodes video frames into video in accordance with any number and/or type(s) of video encoding specifications and/or standards.

To stream video encoded by the example video encoder 224 to, for example, the example projector 114, the example masking streamer 102 includes an example streamer 226. The example streamer 226 streams video in accordance with any number and/or type(s) of video streaming specifications and/or standards.

Because, in the illustrated example of FIG. 1, features are automatically recognized in real-time when a video frame 202 is captured, and sensitive information automatically obscured in that video frame 202 before the video frame 202 is encoded, stored, streamed, etc. the opportunity for a person to be exposed to sensitive information in the frame 202 is reduced, eliminated, etc.

While shown separately in FIG. 2, the masking streamer 102 can be integrated with the video camera 104 to further prevent access to non-obscured video data. For example, the video camera 104 and the masking streamer 102 can be implemented using an INTEL® REALSENSE™ camera. In some examples, the masking streamer 102 is implemented in hardware, in a trusted execution environment, etc. to prevent tampering with frames, object recognition and/or masking. An example trusted execution environment is a secure area of a processor that ensures code and data loaded inside the secure area is protected with respect to confidentiality and integrity.

In some examples, a person can use an example user interface 228 to manage the feature list 206 and/or the policies 216. The feature list 206 corresponds to the features that the analytics engine 204 has been trained to detect. Accordingly, the feature list 206 is, in some examples, only modifiable by an administrator. In some examples, an attendee of a video collaboration session can manage the policies 216 on a call-by-call basis based on, for example, the topic of a meeting, attendees, etc. In some examples, only an administrator can manage the policies 216.

While an example manner of implementing the masking streamer 102 of FIG. 1 is illustrated in FIG. 2, one or more of the elements, processes and/or devices illustrated in FIG. 2 may be combined, divided, re-arranged, omitted, eliminated and/or implemented in any other way. Further, the example analytics engine 204, the example object recognizer 210, the example person recognizer 212, the example content recognizer, the example policy enforcer 218, the example mask calculator 220, the example masker 222, the example video encoder 224, the example streamer 226, the example user interface 228 and/or, more generally, the example masking streamer 102 of FIG. 2 may be implemented by hardware, software, firmware and/or any combination of hardware, software and/or firmware. Thus, for example, any of the example analytics engine 204, the example object recognizer 210, the example person recognizer 212, the example content recognizer, the example policy enforcer 218, the example mask calculator 220, the example masker 222, the example video encoder 224, the example streamer 226, the example user interface 228 and/or, more generally, the example masking streamer 102 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)), field programmable gate array(s) (FPGA(s)), and/or field programmable logic device(s) (FPLD(s)). When reading any of the apparatus or system claims of this patent to cover a purely software and/or firmware implementation, at least one of the example analytics engine 204, the example object recognizer 210, the example person recognizer 212, the example content recognizer, the example policy enforcer 218, the example mask calculator 220, the example masker 222, the example video encoder 224, the example streamer 226, the example user interface 228 and/or, more generally, the example masking streamer 102 is/are hereby expressly defined to include a non-transitory computer readable storage device or storage disk such as a memory, a digital versatile disk (DVD), a compact disk (CD), a Blu-ray disk, etc. including the software and/or firmware. Further still, the example masking streamer 102 of FIG. 2 may include one or more elements, processes and/or devices in addition to, or instead of, those illustrated in FIG. 2, and/or may include more than one of any or all the illustrated elements, processes and devices.

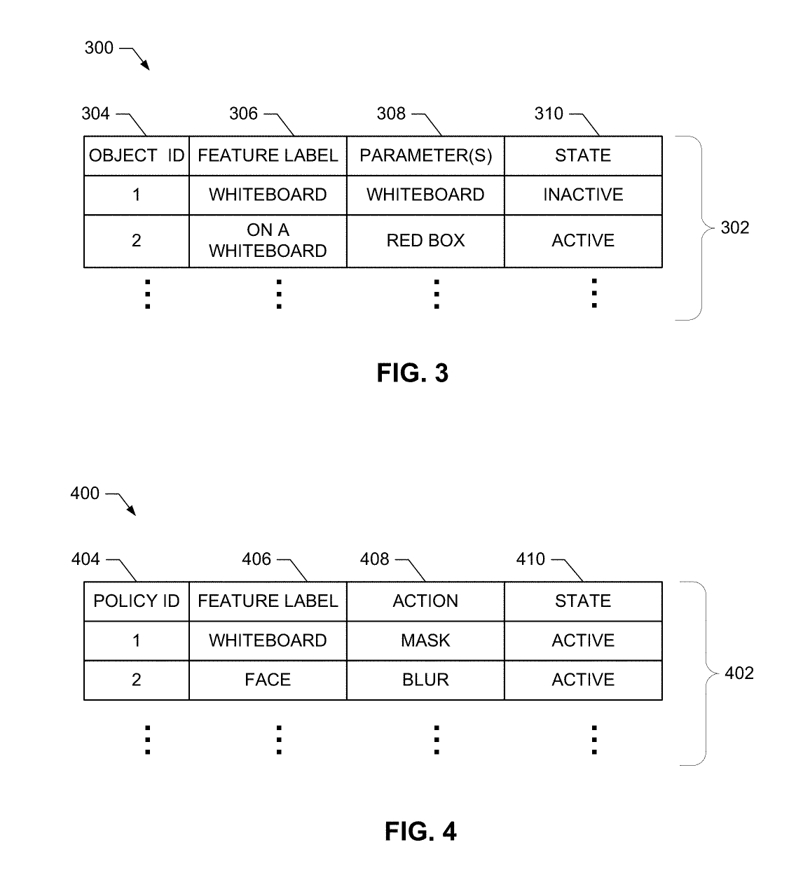

Turning to FIG. 3, an example data structure in the form of a table 300 is shown that may be used to implement the example feature list 206 of FIG. 2. The example table 300 of FIG. 3 includes a plurality of entries 302 for respective ones of a plurality of features. Each of the example entries 302 of FIG. 3 includes an example object identifier 304 (e.g., 1, 2, 3, . . . ), an example feature label 306 (e.g., whiteboard), one or more example parameters 308, and an example state 310 (e.g., active or inactive) representing whether masking of the feature is active. Consider for example, object identifier #2, which has a feature label 306 of “on a whiteboard,” and parameter(s) 308 of “red box.” Accordingly, when the state 310 is “active,” the analytics engine 204 looks for a red box on a whiteboard. While an example data structure 300 that may be used to implement the example feature list 206 is shown in FIG. 3, one or more of the elements illustrated in FIG. 3 may be combined, divided, re-arranged, omitted, eliminated and/or implemented in any other way.

Turning to FIG. 4, an example data structure in the form of a table 400 is shown that may be used to implement the example policies 216 of FIG. 2. The example table 400 of FIG. 4 includes a plurality of entries 402 for respective ones of a plurality of policies. Each of the example entries 402 of FIG. 4 includes an example policy identifier 404 (e.g., 1, 2, 3, . . . ), an example feature label 406 (e.g., whiteboard), an example obscuration action 408 to take (e.g., mask, blur, etc.), and an example state 410 representing whether the policy is, for example, active or inactive. When the example analytics engine 204 finds the red box on a whiteboard object of FIG. 3, which corresponds to policy identifier #1 for a whiteboard, the policy enforcer 218 checks whether the state 410 of the policy identifier #1 is active. If the policy is active, the policy enforcer 218 applies the action 408 of mask (e.g., cover up) the red box on the whiteboard. While an example data structure 400 that may be used to implement the example policies 216 of FIG. 2 is shown in FIG. 4, one or more of the elements illustrated in FIG. 4 may be combined, divided, re-arranged, omitted, eliminated and/or implemented in any other way.

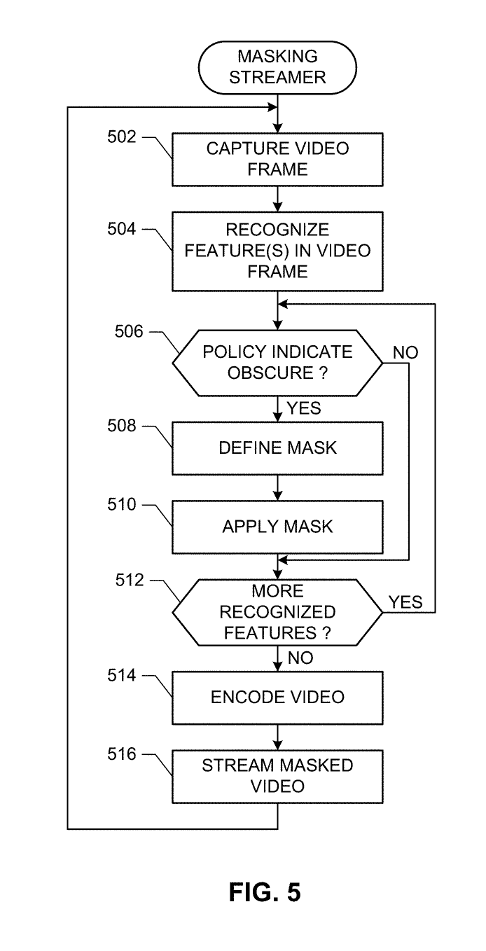

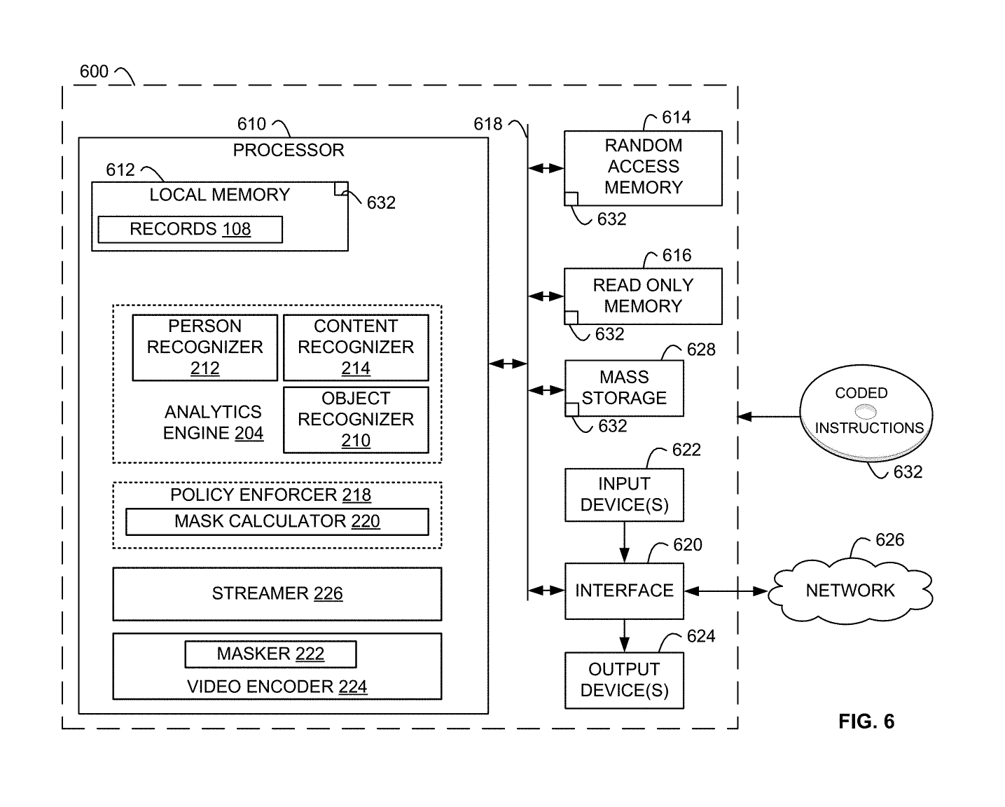

A flowchart representative of example machine-readable instructions for implementing the masking streamer 102 of FIG. 1 and/or FIG. 2 is shown in FIG. 5. In this example, the machine-readable instructions comprise a program for execution by a processor such as the processor 610 shown in the example processor platform 600 discussed below in connection with FIG. 6. The program may be embodied in software stored on a non-transitory computer readable storage medium such as a CD, a floppy disk, a hard drive, a DVD, a Blu-ray disk, or a memory associated with the processor 610, but the entire program and/or parts thereof could alternatively be executed by a device other than the processor 610 and/or embodied in firmware or dedicated hardware. Further, although the example program is described with reference to the flowchart illustrated in FIG. 5, many other methods of implementing the example masking streamer 102 may alternatively be used. For example, the order of execution of the blocks may be changed, and/or some of the blocks described may be changed, eliminated, or combined. Additionally, and/or alternatively, any or all the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

As mentioned above, the example processes of FIG. 5 may be implemented using coded instructions (e.g., computer and/or machine-readable instructions) stored on a non-transitory computer and/or machine-readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

The example program of FIG. 5 begins at block 502. At block 502, the example camera 104 captures a frame of video 202 (block 502). The example analytics engine 204 recognizes in the video frame 202 features specified in the feature list 206 (block 504). For example, the analytics engine 204 passes the video frame 202 through one or more machine learning engines and/or neural networks. For a first recognized feature, the policy enforcer 218 queries the policies 216 to determine whether the feature is to be obscured (block 506). If the feature is to be obscured (block 506), the mask calculator 220 defines the mask to be applied (block 508). For example, the mask calculator 220 obtains from the policies 216 the type of obscuration to be applied, obtains from the analytics engine 204 the location, size, shape, dimension(s), etc. of the feature, and determines the coordinates in the video frame that define the boundary of the feature to be obscured. The example masker 222 applies the mask defined by the example mask calculator 220 (block 510). For example, the example masker 222 computes obscuration data based on the location, size, shape, dimension(s), etc. of the feature computed by the mask calculator 220 that can be combined with or applied to the video frame 202 to obscure the feature in the image frame, applies a function (e.g., a blurring function) to the video frame 202, etc. If there are more features that were recognized (block 512), control returns to block 506 to process the next feature. If there are no more recognized features (block 512), the video encoder 224 encodes the masked video frame (block 514), and the streamer 226 streams the encoded video frame (block 516). Control then returns to block 502 to capture the next video frame.

FIG. 6 is a block diagram of an example processor platform 600 capable of executing the instructions of FIG. 5 to implement the masking streamer 102 of FIG. 1 and/or FIG. 2. The processor platform 600 can be, for example, a server, a personal computer, a workstation, a mobile device (e.g., a cell phone, a smart phone, a tablet such as an iPad™), a personal digital assistant (PDA), an Internet appliance, an Internet-of-Things (IoT) device, a DVD player, a CD player, a digital video recorder, a Blu-ray player, a gaming console, a personal video recorder, a set top box, or any other type of computing device.

The processor platform 600 of the illustrated example includes a processor 610. The processor 610 of the illustrated example is hardware. For example, the processor 610 can be implemented by one or more integrated circuits, logic circuits, microprocessors, GPUs, DSPs or controllers from any desired family or manufacturer. The hardware processor may be a semiconductor based (e.g., silicon based) device. In this example, the processor implements the analytics engine 204, the example object recognizer 210, the example person recognizer 212, the example content recognizer, the example policy enforcer 218, the example mask calculator 220, the example masker 222, the example video encoder 224, the example streamer 226, and the example user interface 228.

The processor 610 of the illustrated example includes a local memory 612 (e.g., a cache). The processor 610 of the illustrated example is in communication with a main memory including a volatile memory 614 and a non-volatile memory 616 via a bus 618. The volatile memory 614 may be implemented by Synchronous Dynamic Random-access Memory (SDRAM), Dynamic Random-access Memory (DRAM), RAMBUS® Dynamic Random-access Memory (RDRAM®) and/or any other type of random-access memory device. The non-volatile memory 616 may be implemented by flash memory and/or any other desired type of memory device. Access to the main memory 614, 616 is controlled by a memory controller (not shown).

The processor platform 600 of the illustrated example also includes an interface circuit 620. The interface circuit 620 may be implemented by any type of interface standard, such as an Ethernet interface, a universal serial bus (USB) interface, a Bluetooth® interface, a near field communication (NFC) interface, and/or a peripheral component interface (PCI) express interface.

In the illustrated example, one or more input devices 622 are connected to the interface circuit 620. The input device(s) 622 permit(s) a user to enter data and/or commands into the processor 610. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 624 are also connected to the interface circuit 620 of the illustrated example. The output devices 624 can be implemented, for example, by display devices (e.g., a light emitting diode (LED), an organic light emitting diode (OLED), a liquid crystal display (LCD), a cathode ray tube display (CRT), an in-plane switching (IPS) display, a touchscreen, etc.) a tactile output device, a printer, and/or speakers. The interface circuit 620 of the illustrated example, thus, typically includes a graphics driver card, a graphics driver chip and/or a graphics driver processor.

The interface circuit 620 of the illustrated example also includes a communication device such as a transmitter, a receiver, a transceiver, a modem, a residential gateway, and/or network interface to facilitate exchange of data with external machines (e.g., computing devices of any kind) via a network 626 (e.g., an Ethernet connection, a digital subscriber line (DSL), a telephone line, a coaxial cable, a cellular telephone system, a Wi-Fi system, etc.). In some examples of a Wi-Fi system, the interface circuit 6p20 includes a radio frequency (RF) module, antenna(s), amplifiers, filters, modulators, etc.

The processor platform 600 of the illustrated example also includes one or more mass storage devices 628 for storing software and/or data. Examples of such mass storage devices 628 include floppy disk drives, hard drive disks, CD drives, Blu-ray disk drives, redundant array of independent disks (RAID) systems, and DVD drives.

Coded instructions 632 including the coded instructions of FIG. 5 may be stored in the mass storage device 628, in the volatile memory 614, in the non-volatile memory 616, and/or on a removable tangible computer readable storage medium such as a CD or DVD.

From the foregoing, it will be appreciated that example methods, apparatus and articles of manufacture have been disclosed that protect sensitive information in video collaboration systems. From the foregoing, it will be appreciated that methods, apparatus and articles of manufacture have been disclosed which enhance the operations of video collaboration systems by automatically recognizing, in real-time, features in video frames that may contain sensitive information as each video frame is captured, and automatically obscuring those features in the video frame before the video frame is encoded, stored, streamed, etc. Such systems reduce the opportunity for a person to be exposed to sensitive information in the video frame before it obscured.

Example methods, apparatus, and articles of manufacture to protect sensitive information in video collaboration systems are disclosed herein. Further examples and combinations thereof include at least the following.

Example 1 is a masking video streamer including:

an analytics engine to recognize a feature in a first frame of a first video stream;

a policy enforcer to apply an obscuration policy to the recognized feature to identify whether to mask the recognized feature; and

a masker to obscure the recognized feature in the first frame to form a second frame in a second video stream.

Example 2 is the masking video streamer of example 1, further including a video camera to capture the first frame of the first video stream, and a streamer to stream the second video stream.

Example 3 is the masking video streamer of example 2, further including a housing, the video camera, the analytics engine, the policy enforcer, the masker, and the streamer implemented in the housing.

Example 4 is the masking video streamer of example 1, wherein the analytics engine, the policy enforcer, and the masker are implemented in a trusted execution environment.

Example 5 is the masking video streamer of example 1, wherein the masker is to obscure the recognized feature by combining the first frame with an image that at least partially obscures the recognized feature.

Example 6 is the masking video streamer of example 1, further including a non-transitory computer-readable storage medium storing a list of features, wherein the analytics engine recognizes the feature based on the list of features.

Example 7 is the masking video streamer of example 1, further including a video encoder to encode the second frame.

Example 8 is the masking video streamer of example 1, wherein the recognized feature includes at least one of a face, a whiteboard, a portion of a whiteboard, a computer screen, a phone screen, or a projection screen.

Example 9 is the masking video streamer of example 1, wherein the policy enforcer includes a mask calculator to determine a portion of the first frame to obscure.

Example 10 is the masking video streamer of example 1, wherein obscuring the recognized feature includes at least one of blurring, or a black box.

Example 11 is the masking video streamer of example 1, wherein the analytics engine is to recognize the feature based on a generic object definition.

Example 12 is a method including:

recognizing, by executing an instruction with a processor, a feature in a first image;

querying a policy, by executing an instruction with the processor, to determine whether to obscure the feature;

when the feature is to be obscured, modifying, by executing an instruction with the processor, the first image to obscure the feature in the first image to form a second image; and

sending, by executing an instruction with the processor, the second image for playback by a projector.

Example 13 is the method of example 12, wherein modifying the first image to obscure the feature includes combining the first image and a third image, the third image including a portion that obscures the feature.

Example 14 is the method of example 12, wherein modifying the first image to obscure the feature includes combining the first frame with an image that at least partially obscures the recognized feature.

Example 15 is the method of example 12, wherein modifying the first image to obscure the feature includes encoding the second frame.

Example 16 is the method of example 12, wherein modifying the first image to obscure the feature includes determining a portion of the first frame to obscure.

Example 17 is the method of example 12, wherein recognizing the feature in the first image is based on a generic object definition.

Example 18 is a non-transitory computer-readable storage medium comprising instructions that, when executed, cause a machine to perform operations including:

recognizing, by executing an instruction with a processor, a feature in a first image;

querying a policy, by executing an instruction with the processor, to determine whether to obscure the feature;

when the feature is to be obscured, modifying, by executing an instruction with the processor, the first image to obscure the feature in the first image to form a second image; and

sending, by executing an instruction with the processor, the second image for playback by a projector.

Example 19 is the non-transitory computer-readable storage medium of example 18, wherein the operations further include recognizing the feature in the first image based on a generic object definition.

Example 20 is the non-transitory computer-readable storage medium of sample 18, wherein the operations further include modifying the first image to obscure the feature by combining the first frame with an image that at least partially obscures the recognized feature.

Example 21 is a masking video streamer including:

an analytics engine to recognize a feature in a first frame of a first video stream;

a policy enforcer to apply an obscuration policy to the recognized feature to identify whether to mask the recognized feature; and

a masker to obscure the recognized feature in the first frame to form a second frame in a second video stream.

Example 22 is the masking video streamer of example 21, further including:

a video camera to capture the first frame of the first video stream; and

a streamer to stream the second video stream.

Example 23 is the masking video streamer of example 22, further including a housing, the video camera, the analytics engine, the policy enforcer, the masker, and the streamer implemented in the housing.

Example 24 is the masking video streamer of any of examples 21 to 23, wherein the analytics engine, the policy enforcer, and the masker are implemented in a trusted execution environment.

Example 25 is the masking video streamer of any of examples 21 to 24, wherein the masker is to obscure the recognized feature by combining the first frame with an image that at least partially obscures the recognized feature.

Example 26 is the masking video streamer of any of examples 21 to 25, further including a non-transitory computer-readable storage medium storing a list of features, wherein the analytics engine recognizes the feature based on the list of features.

Example 27 is the masking video streamer of any of examples 21 to 26, further including a video encoder to encode the second frame.

Example 28 is the masking video streamer of any of examples 21 to 27, wherein the recognized feature includes at least one of a face, a whiteboard, a portion of a whiteboard, a computer screen, a phone screen, or a projection screen.

Example 29 is the masking video streamer of any of examples 21 to 28, wherein the policy enforcer includes a mask calculator to determine a portion of the first frame to obscure.

Example 30 is the masking video streamer of any of examples 21 to 29, wherein the analytics engine is to recognize the feature based on a generic object definition.

Example 31 is a method including:

recognizing, by executing an instruction with a processor, a feature in a first image;

querying a policy, by executing an instruction with the processor, to determine whether to obscure the feature;

when the feature is to be obscured, modifying, by executing an instruction with the processor, the first image to obscure the feature in the first image to form a second image; and

sending, by executing an instruction with the processor, the second image for playback by a projector.

Example 32 is the method of example 31, wherein modifying the first image to obscure the feature includes combining the first image and a third image, the third image including a portion that obscures the feature.

Example 33 is the method of any of examples 31 to 32, wherein modifying the first image to obscure the feature includes combining the first frame with an image that at least partially obscures the recognized feature.

Example 34 is the method of any of examples 31 to 33, wherein modifying the first image to obscure the feature includes encoding the second frame.

Example 35 is the method of any of examples 31 to 34, wherein modifying the first image to obscure the feature includes determining a portion of the first frame to obscure.

A non-transitory computer-readable storage medium comprising instructions that, when executed, cause a computer processor to perform the method of any of claims 31 to 35.

Example 37 is a system including:

means for recognizing, by executing an instruction with a processor, a feature in a first image;

means for querying a policy, by executing an instruction with the processor, to determine whether to obscure the feature;

means for, when the feature is to be obscured, modifying, by executing an instruction with the processor, the first image to obscure the feature in the first image to form a second image; and

means for sending, by executing an instruction with the processor, the second image for playback by a projector.

Example 38 is the system of example 37, wherein the means for modifying the first image to obscure the feature includes combines the first image and a third image, the third image including a portion that obscures the feature.

Example 39 is the system of any of examples 37 to 38, wherein the means for modifying the first image to obscure the feature combines the first frame with an image that at least partially obscures the recognized feature.

Example 40 is the system of any of examples 37 to 39, wherein the means for modifying the first image to obscure the feature encodes the second frame.

Example 41 is the system of any of examples 37 to 40, wherein the means for modifying the first image to obscure the feature determines a portion of the first frame to obscure.

Example 42 is the system of any of examples 37 to 41, wherein the means for recognizing the feature in the first image recognizes the feature based on a generic object definition.

“Including” and “comprising” (and all forms and tenses thereof) are used herein to be open ended terms. Thus, whenever a claim lists anything following any form of “include” or “comprise” (e.g., comprises, includes, comprising, including, has, etc.), it is to be understood that additional elements, terms, etc. may be present without falling outside the scope of the corresponding claim. As used herein, when the phrase “at least” is used as the transition term in a preamble of a claim, it is open-ended in the same manner as the term “comprising” and “including” are open ended. Conjunctions such as “and,” “or,” and “and/or” are inclusive unless the context clearly dictates otherwise. For example, “A and/or B” includes A alone, B alone, and A with B. In this specification and the appended claims, the singular forms “a,” “an” and “the” do not exclude the plural reference unless the context clearly dictates otherwise.

Any references, including publications, patent applications, and patents, cited herein are hereby incorporated by reference to the same extent as if each reference were individually and specifically indicated to be incorporated by reference and were set forth in its entirety herein.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A masking video streamer, comprising:
an analytics engine to recognize a feature in a first frame of a first video stream;
a policy enforcer to apply an obscuration policy to the recognized feature to identify whether to mask the recognized feature; and
a masker to obscure the recognized feature in the first frame to form a second frame in a second video stream.

2. The masking video streamer of claim 1, further including:
a video camera to capture the first frame of the first video stream; and
a streamer to stream the second video stream.

3. The masking video streamer of claim 2, further including a housing, the video camera, the analytics engine, the policy enforcer, the masker, and the streamer implemented in the housing.

4. The masking video streamer of claim 1, wherein the analytics engine, the policy enforcer, and the masker are implemented in a trusted execution environment.

5. The masking video streamer of claim 1, wherein the masker is to obscure the recognized feature by combining the first frame with an image that at least partially obscures the recognized feature.

6. The masking video streamer of claim 1, further including a non-transitory computer-readable storage medium storing a list of features, wherein the analytics engine recognizes the feature based on the list of features.

7. The masking video streamer of claim 1, further including a video encoder to encode the second frame.

8. The masking video streamer of claim 1, wherein the recognized feature includes at least one of a face, a whiteboard, a portion of a whiteboard, a computer screen, a phone screen, or a projection screen.

9. The masking video streamer of claim 1, wherein the policy enforcer includes a mask calculator to determine a portion of the first frame to obscure.

10. The masking video streamer of claim 1, wherein obscuring the recognized feature includes at least one of blurring, or a black box.

11. The masking video streamer of claim 1, wherein the analytics engine is to recognize the feature based on a generic object definition.

12. A method, comprising:
recognizing, by executing an instruction with a processor, a feature in a first image;
querying a policy, by executing an instruction with the processor, to determine whether to obscure the feature;
when the feature is to be obscured, modifying, by executing an instruction with the processor, the first image to obscure the feature in the first image to form a second image; and
sending, by executing an instruction with the processor, the second image for playback by a projector.

13. The method of claim 12, wherein modifying the first image to obscure the feature includes combining the first image and a third image, the third image including a portion that obscures the feature.

14. The method of claim 12, wherein modifying the first image to obscure the feature includes combining the first frame with an image that at least partially obscures the recognized feature.

15. The method of claim 12, wherein modifying the first image to obscure the feature includes encoding the second frame.

16. The method of claim 12, wherein modifying the first image to obscure the feature includes determining a portion of the first frame to obscure.

17. The method of claim 12, wherein recognizing the feature in the first image is based on a generic object definition.

18. A non-transitory computer-readable storage medium comprising instructions that, when executed, cause a machine to perform operations including:
recognizing, by executing an instruction with a processor, a feature in a first image;
querying a policy, by executing an instruction with the processor, to determine whether to obscure the feature;
when the feature is to be obscured, modifying, by executing an instruction with the processor, the first image to obscure the feature in the first image to form a second image; and
sending, by executing an instruction with the processor, the second image for playback by a projector.

19. The non-transitory computer-readable storage medium of claim 18, wherein the operations further include recognizing the feature in the first image based on a generic object definition.

20. The non-transitory computer-readable storage medium of claim 18, wherein the operations further include modifying the first image to obscure the feature by combining the first frame with an image that at least partially obscures the recognized feature.
